(19) United States
(12) Patent Application Publication
(10) Pub. No.: US 2025/0240370 A1
(43) Pub. Date: Jul. 24, 2025

(54) METHODS AND SYSTEMS FOR INTERNAL FRAUD CONTROL BASED ON VOLUME AND TIME CONSTRAINTS OF REJECTED CALL RECORDS

(71) Applicant: Telefonaktiebolaget LM Ericsson (publ), Stockholm (SE)

(72) Inventors: Celso Bernardo Da Nobrega De FREITAS, SÃO JOSÉ DOS CAMPOS SÃO PAULO (BR); Maíra ALMEIDA, Cacapava (BR); Roberto Pires De CARVALHO, São Paulo SP (BR); Kleber de Mattos DOBROWOLSKI, Sao Paulo Sao Paulo (BR)

(21) Appl. No.: 18/698,550

(22) PCT Filed: Oct. 4, 2021
(86) PCT No.: PCT/SE2021/050973

§ 371 Date: Apr. 4, 2024

(51) Int. Cl. H04M 15/00

(52) U.S. Cl. CPC H04M 15/47

(57) ABSTRACT

Systems and methods are provided for processing a call data record (CDR) in a communication network. The method includes: receiving a rejected CDR; determining if a characteristic feature of the rejected CDR exceeds a threshold; performing a validation on the determination of the rejected CDR when the characteristic feature exceeds the first threshold; removing access of a subscriber associated with the CDR from the communication network when the validation of the rejected CDR is negative; and continuing to allow access of the subscriber associated with the CDR to the communication network when the validation of the rejected CDR is positive.

### TECHNICAL FIELD

The present invention generally relates to communication networks and, more particularly, to mechanisms and techniques for fraud control in telecommunication systems.

### BACKGROUND

Over time the number of products and services provided to users of telecommunication products has grown significantly. For example, in the early years of wireless communication, devices could be used for conversations and later also had the ability to send and receive text messages. Further, technology advanced and wireless phones of varying capabilities were introduced which had access to various services provided by network operators, e.g., data services, such as streaming video or music service. More recently there are numerous devices, e.g., so called “smart” phones and tablets, which can access communication networks in which the operators of the networks, and other parties, provide many different types of services, applications, etc. Thus, it can be seen that there has been a growth of products and services which is expected to continue as technology continues to advance.

An example of how telecommunication services and products are provided to such devices will now be described with respect to a Customer Care and Billing (CC & B) platform which may be a part of an operator's Business Support System (BSS). In the CC & B, the services that a customer can use, e.g., sending a Short Message Service (SMS) to another party or utilizing mobile data, are modelled as services which are realized through a product specification and a product offering. A product offering is an item that a customer actually sees to purchase. This product offering can be a single product or a bundled product. Examples of single products include voice, data or SMS products. An example of a bundled service is an offering that allows 500 minutes of voice, 50 gigabytes (GB) of data and 200 SMS texts.

For any end user, there is a representation of the products and services within the CC & B which can be in the form of an account that captures mapping of the assigned offerings with the actual resources that are allocated to an end user or subscriber. In order to manage usage of services and to charge the customer based on the usage, an operator typically hosts an CC & B in its network. This node or set of nodes is responsible for determining the requested usage, looking at the state of the account and making a determination of how much usage to grant to the user. Considering products and services offered and the large amounts of money involved, fraud is issue with respect to lost revenues. Thus, the earlier that fraud is detected, the lower the losses due to fraud will be. One of the main types of fraud is the so-called internal fraud. In this context, internal fraud can be described as the case where a malicious user with access (granted or via back-door) to the internal operator's network provisions a subscriber profile across the HLR/HSS/FNR (network system) but not at the CC & B platform which includes a customer register database while also being responsible for handling post-paid business issues, e.g., contracts, billing and customer life cycle. This way, such a malicious user can make calls, send texts, and access the network but is never charged for those services until the fraudulent usage is discovered by the operator of the network.

Most CC & B platforms can detect unknown subscribers or non-provisioned services when rating the call detail records, e.g., a call data record (CDR) which comes from the network, by rejecting them. However, it is up to the network operator to decide how and when to treat such information as indicative of fraudulent usage, which usually takes time and resources and which, therefor, can increase revenue losses.

At the same time, activation delay of subscribers or services across the network and the CC & B is a common situation. Activation delay can be described as the time interval between the event of a user activating a new subscription or service on the operator's network and the event of that subscription or service being officially activated in the operator's CC & B. During this time interval, which is normally no longer than a few hours, the subscriber is allowed to use the service in order to provide a good customer experience from the start of the new subscription. Therefore, unbilled activity associated with unsubscribed internal fraud and validly subscribed activation delay are commonly indistinguishable.

Currently, there are some examples of attempts at solutions with respect to the above-described fraud issue. For example, reports of network and CC & B discrepancies can be generated based on billing data, and later manually analyzed by people to identify and deactivate fraudulent subscribers. Further currently considered or implemented examples include training of machine learning (ML) modules based on subscriber and CDR data as well as a probabilistic method to detect telecommunication fraud with corrupted CDRs. However, it is not believed that these implementations or potential implementations acceptably reduce the revenue losses due to internal fraud.

Further, for example, the reconciliation of subscribers across the operator's network and the CC & B to identify discrepancies can be performed either manually after the fact or in a more real-time fashion. Manually, this can be performed by detecting the subscribers that are in the network and not in the CC & B and then generating a report to be later analyzed before deactivating those subscribers. However, this takes time which increases the losses due to fraud. In real-time, this can be performed by immediately deactivating subscribers that are in the network but not in the CC & B. However, as temporary delays in activations in the network exist, immediately deactivating all subscribers with this condition means that numerous valid subscribers could lose their network connectivity which would generate complaints about recently activated services not working which is also undesirable.

Thus, there is a need to provide methods and systems that overcome the above-described drawbacks associated with this type of telecommunication fraud.

### SUMMARY

Embodiments allow for improved methods and systems for dealing with internal fraud in networks. This can be implemented with substantially automatic processes for deactivating fraudulent subscribers and services while also allowing for valid subscribers to not be negatively impacted.

According to an embodiment, there is a method for processing a call data record (CDR) in a communication network. The method includes: receiving a rejected CDR; determining if a characteristic feature of the rejected CDR exceeds a first threshold; performing a validation on the determination of the rejected CDR when the characteristic feature exceeds the first threshold; removing access of a subscriber associated with the CDR from the communication network when the validation of the rejected CDR is negative; and continuing to allow access of the subscriber associated with the CDR to the communication network when the validation of the rejected CDR is positive.

According to an embodiment, there is a system for processing a call data record (CDR) in a communication network. The system includes: a communication interface configured to receive a rejected CDR; a processor configured to determine if a characteristic feature of the rejected CDR exceeds a first threshold; the processor configured to perform a validation on the determination of the rejected CDR when the characteristic feature exceeds the first threshold; the processor configured to remove access of a subscriber associated with the CDR from the communication network when the validation of the rejected CDR is negative; and the processor configured to continue to allow access of the subscriber associated with the CDR to the communication network when the validation of the rejected CDR is positive.

According to an embodiment, there is a computer-readable storage medium containing a computer-readable code that when read by a processor causes the processor to process a call data record (CDR) in a communication network. The method includes: receiving a rejected CDR; determining if a characteristic feature of the rejected CDR exceeds a first threshold; performing a validation on the determination of the rejected CDR when the characteristic feature exceeds the first threshold; removing access of a subscriber associated with the CDR from the communication network when the validation of the rejected CDR is negative; and continuing to allow access of the subscriber associated with the CDR to the communication network when the validation of the rejected CDR is positive.

According to an embodiment, there is an apparatus adapted to receive a rejected CDR; adapted to determine if a characteristic of the rejected CDR exceeds a first threshold; adapted to perform a validation on the determination of the rejected CDR when the characteristic feature exceeds the first threshold; adapted to remove access of a subscriber associated with the CDR from the communication network when the validation of the rejected CDR is negative; and adapted to continue to allow access of the subscriber associated with the CDR to the communication network when the validation of the rejected CDR is positive.

According to an embodiment, there is an apparatus including: a first module configured to receive a rejected call data record (CDR); a second module configured to determine if a characteristic feature of the rejected CDR exceeds a first threshold; a third module configured to perform a validation on the determination of the rejected CDR when the characteristic feature exceeds the first threshold; a fourth module configured to remove access of a subscriber associated with the CDR from the communication network when the validation of the rejected CDR is negative; and a fifth module configured to continue to allow access of the subscriber associated with the CDR to the communication network when the validation of the rejected CDR is positive.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows the information flow for processing a rejected call data record (CDR) according to an embodiment;

FIG. 2 depicts a graphical overview of the CDR processing method according to an embodiment;

FIG. 3 shows a sequence diagram of the CDR processing method according to an embodiment;

FIG. 4 shows a signaling diagram for a first scenario according to an embodiment;

FIG. 5 shows a signaling diagram for a second scenario according to an embodiment;

FIG. 6 shows a signaling diagram for a third scenario according to an embodiment;

FIG. 7 shows a flowchart of a method for processing a CDR in a communication network according to an embodiment;

FIG. 8 depicts a communication node according to an embodiment; and

FIG. 9 depicts an electronic storage medium on which computer program embodiments can be stored.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The embodiments to be discussed next are not limited to the configurations described below, but may be extended to other arrangements as discussed later.

Reference throughout the specification to “one embodiment” or “an embodiment” means that a particular feature, structure or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

As described in the Background section, there are problems associated telecommunication fraud. Embodiments described herein provide systems and methods for providing an automatic, real-time internal fraud control while not impacting a regular customer's experience or service availability which may be experiencing an activation delay. Embodiments described herein can be used in current networks, 5G networks and future networks which include similar billing and service delivery abilities.

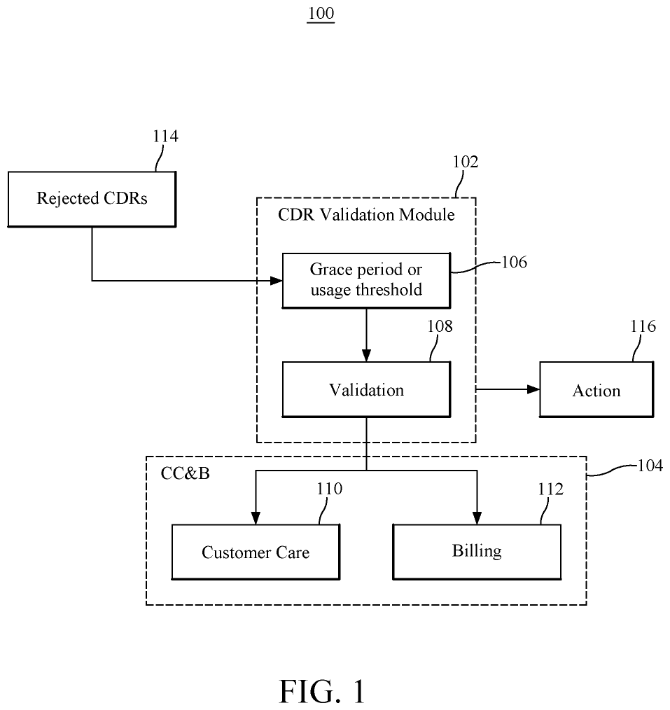

According to an embodiment, FIG. 1 shows the information flow 100 for processing a rejected Call Data Record (CDR) for reducing fraud in the network which can be performed in a node. In FIG. 1, there is a CDR validation module 102 and the CC & B 104 which includes a customer care function 110 and a billing function 112. Initially, rejected CDRs 114 due to an unknown subscriber and/or an unknown service are entered as input to the fraud reduction process at the CDR validation module 102. The subscriber associated with the CDR is tagged and/or associated with a configurable fraud threshold which can be, for example a grace time period or a usage threshold/data amount threshold as shown in step 106. The CDR validation module 102 communicates with the CC & B 104 as shown in step 108 to validate the subscriber and/or service if the threshold has been exceeded. If the validation fails, a provisioning command is sent to the network system to disable the subscriber and/or service as represented by the action step 116. When the validation does not fail, no action to disable the subscriber and/or service is taken by the network.

According to an embodiment, a CDR flow is produced by a node in an operator's network and sent to the CC & B 104. Inside the CC & B 104 there is a rating module which has the ability to reject or accept CDRs. Embodiments allow for CDRs rejected by the rating module due to their being associated with an unknown subscriber or non-provisioned service, to be processed by a node outside of the traditional rating process, i.e., CDR validation can occur in parallel to the rating process, in order to not negatively affect performance of the rating process.

Prior to describing the systems and methods according to these embodiments in detail, an overview is now provided. According to an embodiment, the network sends CDRs to the CC & B 104. The CC & B 104 includes a rating module that accepts or rejects CDRs. Rejected CDRs due to an unknown subscriber and/or service are captured and entered as input for the CDR processing method. For each rejected CDR, a grace period or usage threshold is started if it is the first time an identification of a CDR with respect to a particular subscriber is processed. Otherwise, for subsequent CDRs associated with the same subscriber and when the grace period or usage threshold which was previously started for that subscriber is exceeded, the CC & B 104 is checked to validate or invalidate the usage. More specifically, the CC & B 104 is checked to see whether it recognizes the subscriber and/or service as valid or authorized to use the network.

According to an embodiment, an action is taken depending upon the outcome of the CC & B check. If the CC & B 104 recognizes the subscriber and/or service, the identifying information is stored, e.g., cached, to prevent redundant consultations to the CC & B 104. The stored identifying information can be stored for a limited time period, e.g., to provide a validity threshold such as one day, so that after the validity threshold is exceeded the stored identifying information will expire and the CC & B 104 will again be consulted when a grace period or usage threshold is exceeded. If the CC & B 104 does not recognize the subscriber and/or service, the method requests the network to deactivate the fraudulent subscriber and/or service.

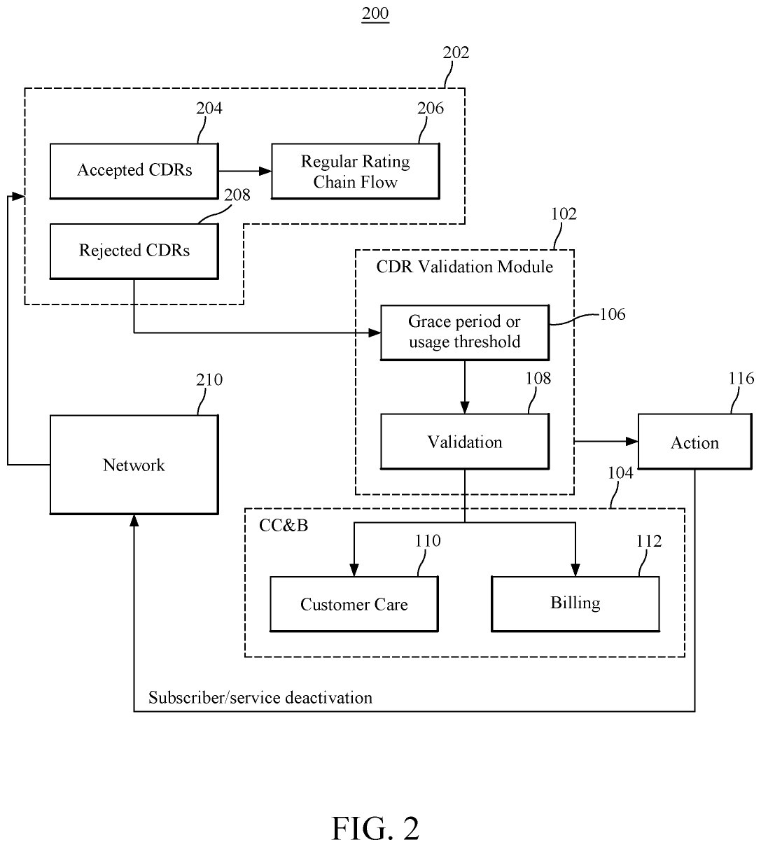

According to an embodiment, a graphical overview of the CDR processing method is now described with respect to FIG. 2. FIG. 2 builds off of the information flow 100 shown in FIG. 1, and also includes a rating module 202 representing the rating chain, which can be located in the CC & B 104, and the network 210. The rating module 202 accepts CDRs as inputs, with accepted CDRs 204 being sent to the regular rating chain flow process 206. CDRs rejected by the rating chain due to the reason “unknown subscriber/not provisioned service” are the inputs used for the rest of the process to be further described. The subscriber and/or service identifications are collected from the CDR and used in the next step by the CDR validation module 102. The CDR itself is typically not stored, reprocessed or rerated in this process. This process operates in parallel to the traditional rating chain to avoid any degradation in the system performance.

CDRs can be rejected on rating for different reasons. Embodiments described herein, focus on back-door provisioning fraud (internal fraud) and CDRs which arrive during the time interval after service provisioning but before subscriber information is updated at the CC & B 104. In order to avoid deactivating subscribers or services due to delays between activations in the CC & B 104 and the network 210, a grace period or a usage threshold can be used. With this grace period or usage threshold, an unknown subscriber could use the network during a preconfigured threshold amount of time or usage even if a CDR associated with that subscriber is rejected. For example, the unknown subscriber could talk for up to 10 minutes, use up to 10 MB of data, be an unknown subscriber for no more than 15 minutes, i.e., the time period between the first and last rejected CDR, with time and/or an amount of data being considered as a characteristic feature of the rejected CDR. Using this threshold, avoids complaints over recently activated services not working from valid subscribers and overloading the CC & B 104 due to constantly checking for subscriber or server status.

According to an exemplary embodiment, validation commences once a rejected CDR arrives after the grace period or usage threshold has ended for an unknown subscriber at the validation module 102. The process can consult the CC & B 104 for the subscriber and/or service described in the rejected CDR. It is up to the CC & B 104 to indicate whether the subscriber and/or services are authorized to use the operator's network 210. No further actions are performed for the other rejected CDRs for the same subscriber and/or service.

Once the validation is performed, there are two possible outcomes which occur as represented by the action block 116. Firstly, the subscriber and/or the service can continue to use the operator's network 210 or the subscriber and/or service cannot continue to use the operator's network. In the first case, when the subscriber and/or service can continue to use the operator's network 210, the result is cached at the validation module 102 to avoid consulting the CC & B again for the possible remaining rejected CDRs for the same subscriber and/or service In the second case, when the subscriber and/or service cannot continue to use the operator's network 210, an automatic provisioning message is built and sent to the operator's network in order to deactivate the unknown subscriber and/or service. The predetermined threshold amount for the subscriber and/or service is reset, allowing for the rejected CDR processing method to be repeated if desired. A report detailing this information can also be generated.

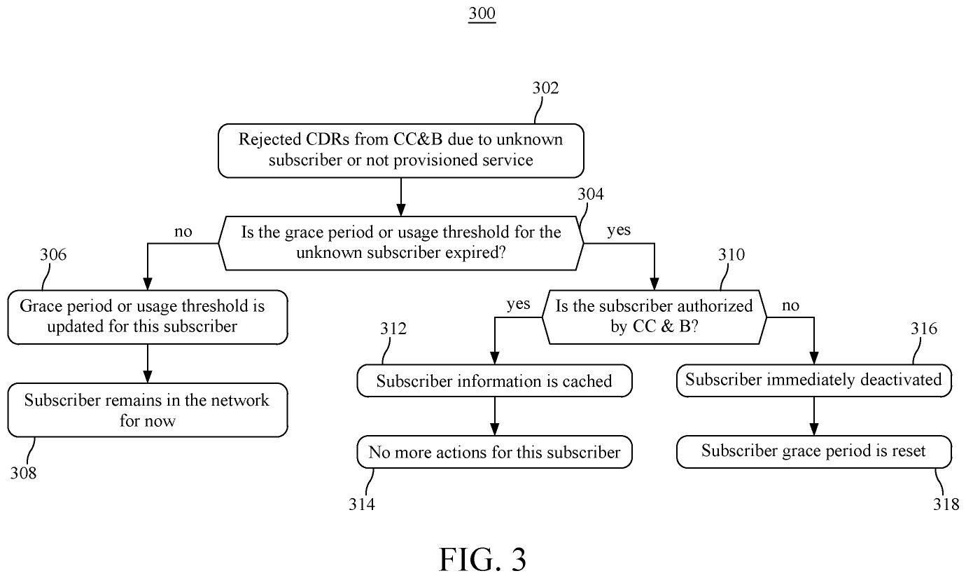

The graphical overview described above with respect to FIG. 2, is now explained in the form of a sequence diagram 300 as shown in FIG. 3. Initially, the process begins with receiving one or more rejected CDRs from the rating module 202 due to being associated with unknown subscribers or not provisioned services as shown in block 302 In block 304 it is determined whether or not the grace period or usage threshold for the unknown subscriber expired or was exceeded. If the determination is no, then as shown in block 306 the grace period or usage threshold is updated for this subscriber and as shown in block 308 the subscriber remains connected to the network for now.

According to an embodiment, when the determination is a yes, i.e., that the threshold has been exceeded or expired, a determination is made in block 310 whether or not the subscriber is authorized by the CC & B 104. If the determination is yes, then the subscriber information is cached as shown in block 312. Then, as shown in block 314, no more actions are taken for this subscriber. When the determination from block 310 is a no, then the subscriber is deactivated from the network as shown in block 316. Then, as shown in block 318, the subscriber grace period/threshold is reset.

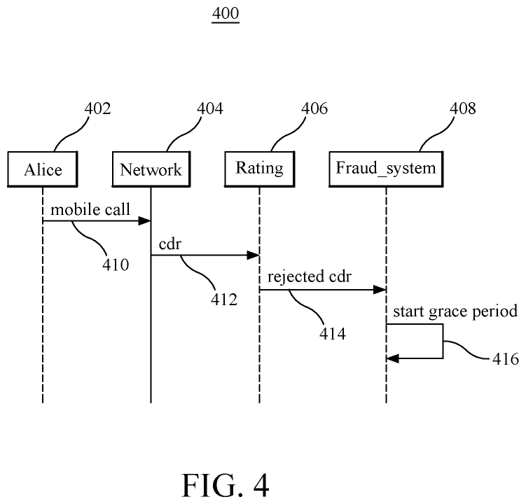

Having described various ways to process the rejected CDRs above, various examples of such are described below with respect to FIGS. 4-6. In the examples below, the operator's network allows for an unknown subscriber to talk for up to 10 minutes, use up to 10 MB of data and/or be an unknown subscriber associated with the network for a time frame of no more than 15 minutes. According to an embodiment, FIG. 4 shows a signaling diagram 400 for a first scenario. The background for first scenario is that there is an out of synchronization subscriber, e.g., a subscriber not activated at the CC & B 104 at this specific point in time, Alice 402, activated in the network 404 but delayed for one minute in the CC & B 104. A single CDR is rejected. This is a non-fraudulent, valid transaction.

For this first scenario, a mobile call 410 is generated by Alice 402 and received by the network 404. The network 404 generates a CDR 412 and transmits it to the rating process 406. The rating process 406 determines that CDR 412 is a rejected CDR 414 and forwards it to the fraud system 408, which performs the processes described above with respect to the validation module 102, interactions with the CC & B 104 and the action block 116 as needed. Therefore, in this first scenario, the validation module 102 determines that the appropriate outcome is to start the grace period 416 and to permit Alice 402 to retain network connectivity.

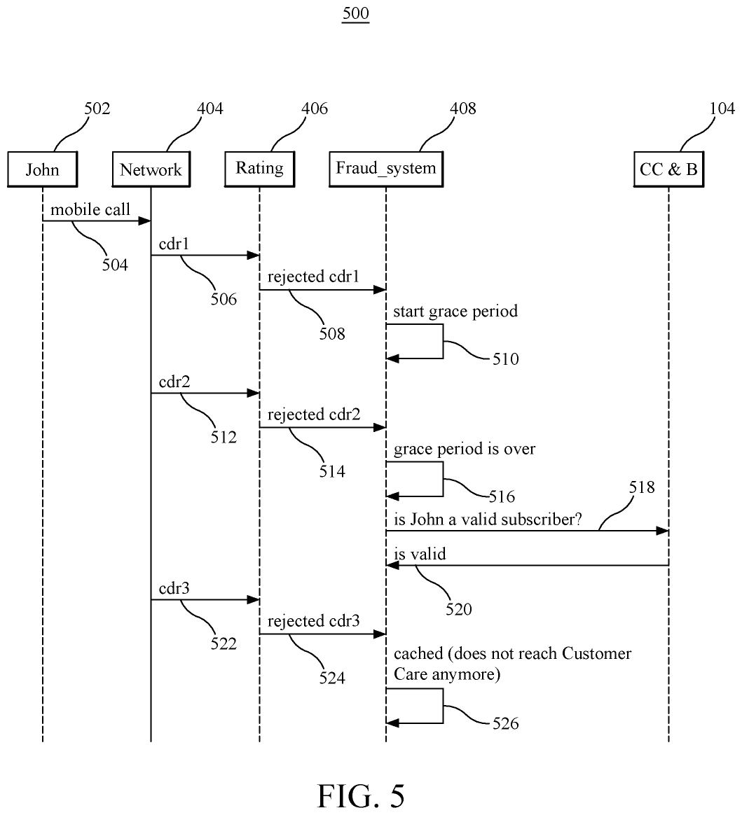

According to an embodiment, FIG. 5 shows a signaling diagram 500 for a second scenario. The background for the second scenario is that there is a subscriber, John 502, who is in synchronization and is activated in the network but was delayed for 10 minutes in the CC & B 104. After the stipulated grace period, the fraud system 408 will validate with the CC & B 104 which will allow usage of the network 404 by the subscriber. If rejected CDRs keep coming after this occurrence, the CC & B 104 will not be consulted anymore for this subscriber as the previous result was cached.

Showing this second scenario in the signaling diagram 500, a mobile call 504 is generated by John 502 and received by the network 404. The network 404 generates a CDR1 506 and transmits it to the rating process 406. The rating process 406 determines that CDR1 506 is a rejected CDR1 508 and forwards it to the fraud system 408, which performs the processes described above with respect to the validation module 102, interactions with the CC & B 104 and the action block 116 as needed. Therefore, at this point in time in this second scenario, the validation module 102 determines that the appropriate outcome is to start the grace period 510 and to permit John 502 to retain network connectivity.

At some point in the future, the network 404 generates another CDR associated with John 502, CDR2 512 and transmits it to the rating process 406. The rating process 406 determines that CDR2 512 is a rejected CDR2 514 and forwards it to the fraud system 408, which performs the processes described above and determines that the grace period is now over at 516. The fraud system 408 transmits a message 518 querying the CC & B 104 as to whether John 502 is a valid subscriber. In this second scenario, the CC & B 104 determines that John 502 is indeed a valid subscriber and informs the fraud system 408 of this result in message 520. This information is then stored for future reference.

Later on, the network 404 generates another CDR associated with John 502, CDR3 522 and transmits it to the rating process 406. The rating process 406 determines that CDR3 522 is a rejected CDR3 524 and forwards it to the fraud system 408, which realizes based on previously stored information that nothing further needs to be done as represented by cached information 526.

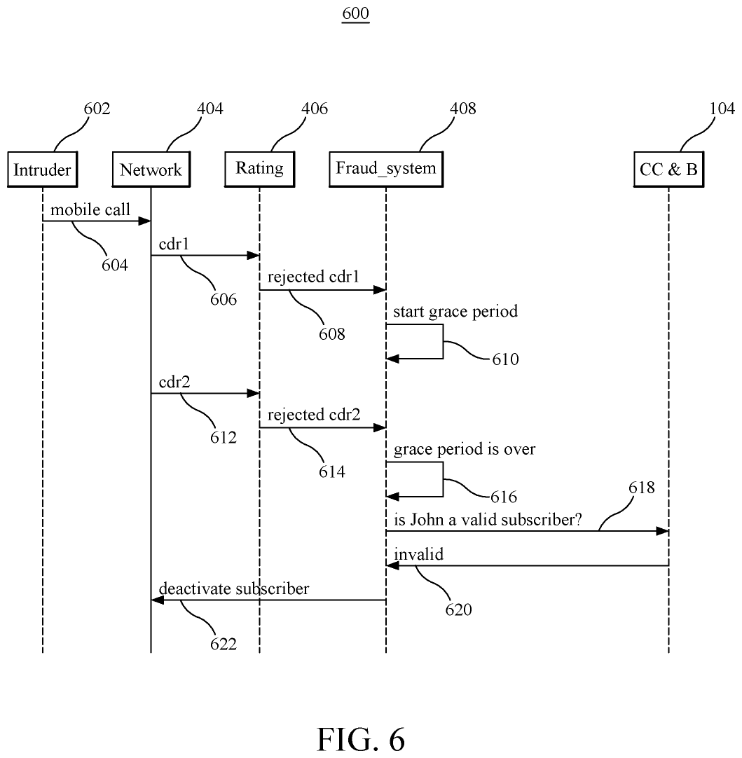

According to an embodiment, FIG. 6 shows a signaling diagram 600 for a third scenario. The background for the third scenario is that there is a fraudulent subscriber that is activated in the network 404 but not in the CC & B 104. After the grace period expires, the fraud control 408 validates with the CC & B 104. The CC & B 104 determines that this subscriber is fraudulent ending in deactivation.

Showing this third scenario in the signaling diagram 600, a mobile call 604 is generated by the intruder 602 and received by the network 404. The network 404 generates a CDR1 606 and transmits it to the rating process 406. The rating process 406 determines that CDR1 606 is a rejected CDR1 608 and forwards it to the fraud system 408, which performs the processes described above with respect to the validation module 102, interactions with the CC & B 104 and the action block 116 as needed. Therefore, at this point in time in this second scenario, the validation module 102 determines that the appropriate outcome is to start the grace period 610.

At some point in the future, the network 404 generates another CDR associated with the same user 602, CDR2 612 and transmits it to the rating process 406. The rating process 406 determines that CDR2 612 is a rejected CDR2 614 and forwards it to the fraud system 408, which performs the processes described above and determines that the grace period is now over 616. The fraud system 408 transmits a message 618 querying the CC & B 104 as to whether the user 602 is a valid subscriber. In this second scenario, the CC & B 104 determines that the user 602 is invalid and informs the fraud system 408 of this result in message 620. A deactivation message 622 is generated by the fraud system 408 and transmitted to the network 404 to deactivate the intruder's network access.

Examples of a timeline of events associated with FIGS. 4-6 are shown below with respect to Table 1.

TABLE 1

| Rejection date | Subscriber | Usage | | Fraud Control Action |
|---|---|---|---|---|
| 2020-08-31 14:00 | Alice | 3 | MB | Start grace period for Alice, usage = 3 MB |
| 2020-08-31 14:01 | John | 2 | min | Start grace period for John, usage = 2 min |
| 2020-08-31 14:02 | Intruder | 1 | MB | Start grace period for Intruder, usage = 1 MB |
| 2020-08-31 14:03 | John | 1 | min | Update John: usage = 3 min |
| 2020-08-31 14:04 | Intruder | 5 | min | Update Intruder: usage = 5 min, 1 MB |
| 2020-08-31 14:05 | Intruder | 6 | min | Usage passed threshold for Intruder, therefore |
| | | | | validate with CC&B if can use the Network. |
| | | | | CC&B says NOK, therefore build and send a |
| | | | | command to Network to deactivate Intruder. |
| | | | | Reset grace period for Intruder. |
| 2020-08-31 14:20 | John | 1 | min | Grace period is over for John, therefore validate |
| | | | | with CC&B if can use the Network. |
| | | | | CC&B says OK, so store the result in cache. |
| 2020-08-31 14:21 | Intruder | 1 | MB | Start grace period for Intruder, usage = 1 MB |
| 2020-08-31 14:22 | John | 2 | min | Nothing to do (cached result for John). |

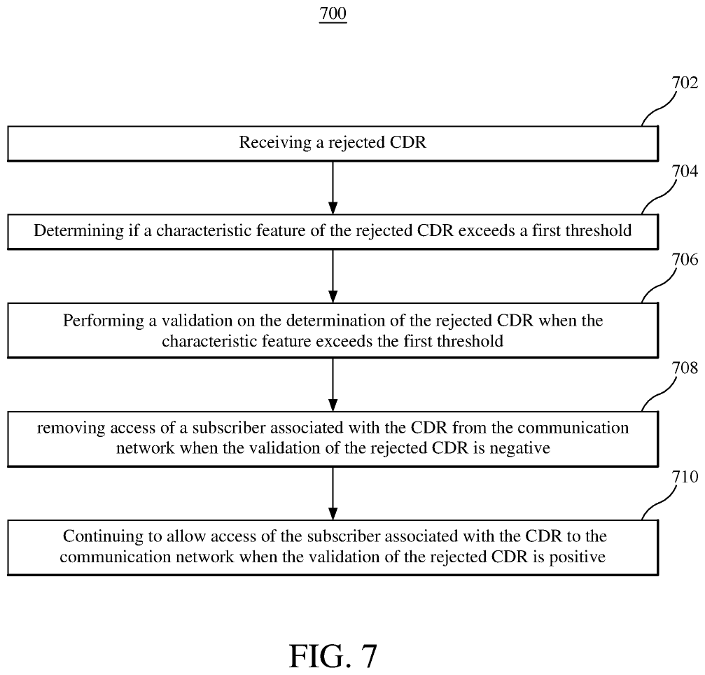

According to an embodiment there is a method 700 for processing a CDR in a communication network as shown in FIG. 7. The method includes: in step 702, receiving a rejected CDR; in step 704, determining if a characteristic feature of the rejected CDR exceeds a first threshold; in step 706, performing a validation on the determination of the rejected CDR when the characteristic feature exceeds the first threshold; in step 708, removing access of a subscriber associated with the CDR from the communication network when the validation of the rejected CDR is negative; and in step 710, continuing to allow access of the subscriber associated with the CDR to the communication network when the validation of the rejected CDR is positive.

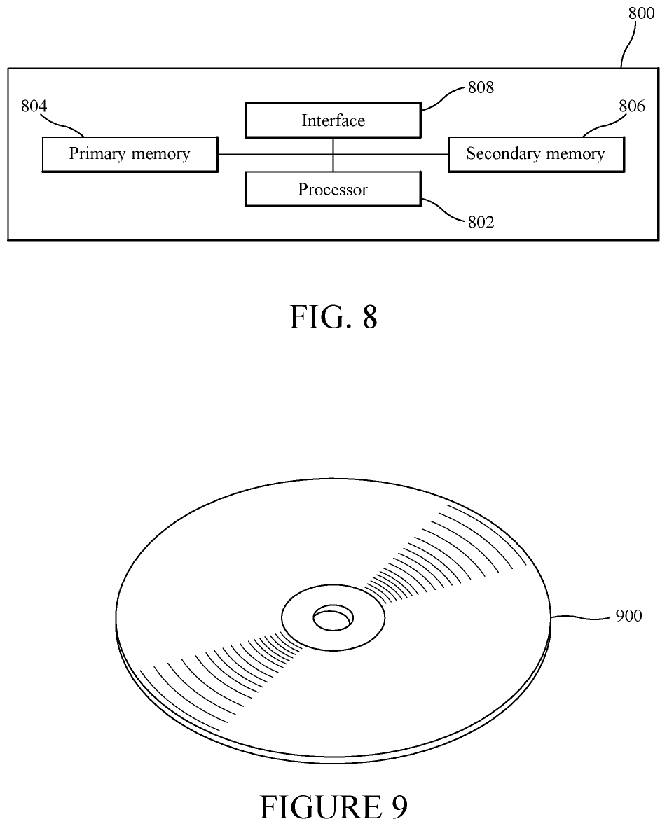

Embodiments described above associated with processing a CDR in a communication network can be implemented in one or more nodes (or servers). An example of a communication node 800 is shown in FIG. 8. The communication node 800 (or other network node) includes a processor 802 for executing instructions and performing the functions described herein. The communication node 800 also includes a primary memory 804, e.g., random access memory (RAM) memory, a secondary memory 806 which can be a non-volatile memory, and an interface 808 for communicating with other portions of a network or among various nodes/servers if, for example, the various functional modules are distributed over multiple servers.

Processor 802 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in conjunction with other communication node 800 components, such as memory 804 and/or 806, in support of the various embodiments described herein. For example, processor 802 may execute instructions stored in memory 804 and/or 806.

Primary memory 804 and secondary memory 806 may comprise any form of volatile or non-volatile computer readable memory including, without limitation, persistent storage, solid state memory, remotely mounted memory, magnetic media, optical media, RAM, read-only memory (ROM), removable media, or any other suitable local or remote memory component. Primary memory 804 and secondary memory 806 may store any suitable instructions, data or information, including software and encoded logic, utilized by node 800. Primary memory 804 and secondary memory 806 may be used to store any calculations made by processor 802 and/or any data received via interface 808.

Communication node 800 also includes interface 808 which may be used in the wired or wireless communication of signaling and/or data. For example, interface 808 may perform any formatting, coding, or translating that may be needed to allow communication node 800 to send and receive data over a wired connection. Interface 808 may also include a radio transmitter and/or receiver that may be coupled to or a part of the antenna. The radio may receive digital data that is to be sent out to other network nodes or wireless devices via a wireless connection. The radio may convert the digital data into a radio signal having the appropriate channel and bandwidth parameters. The radio signal may then be transmitted via an antenna to the appropriate recipient.

According to an embodiment, the methods described herein can be implemented on one or more communication nodes 800 with these nodes 800 being located under control of the network operator. Various embodiments described herein refer in some fashion to nodes, e.g., the node which implements the CDR validation module 102. In some embodiments the non-limiting communication node (also interchangeably called as node) is more commonly used and it refers to any type of network node which directly or indirectly communicates with a UE, a node in the operator's network 210 and the CC & B 104. It can be a radio network node or a node in a core network or fixed part of the network.

Additional nodes which can be used to interact with and/or support the embodiments described herein can include a network node which generates the CDR, a rating/charging node which prices the CDR and decides whether to accept or reject a CDR and a billing node which groups all of the accepted CDRs and invoices them. Accordingly, any of these nodes could be used to implement, for example, the method 700 as shown in FIG. 7. Alternatively, a new, different node could be used for implementing the method 700.

According to an embodiment, implementing the systems and methods described herein provide an automatic method to deactivate fraudulent subscribers with no or minimal human input while optimizing the detection of internal fraud as compared to current solutions. Further, embodiments allow for a grace period of usage. While this can allow for the authorization of fraudulent subscribers to use network services, the amount in terms of cost is negligible and allows for valid subscribers to not be negatively impacted.

Further, embodiments use real time data from different domains, e.g., the rating process, the CC & B 104 and the operator's network 210, which are neglected by currently known anti-fraud solutions associated with rejected CDRs. Network operators do not automatically take actions based on a rejected CDR since they do not want to harm valid customers and or service that are under an activation delay. Further the usage of thresholds, e.g., time grace period and data usage, in this context are advantageous over currently used systems.

The disclosed embodiments provide methods and devices for processing a CDR in a communication network. It should be understood that this description is not intended to limit the invention. On the contrary, the embodiments are intended to cover alternatives, modifications and equivalents, which are included in the spirit and scope of the invention. Further, in the detailed description of the embodiments, numerous specific details are set forth in order to provide a comprehensive understanding of the claimed invention. However, one skilled in the art would understand that various embodiments may be practiced without such specific details.

As also will be appreciated by one skilled in the art, the embodiments may take the form of an entirely hardware embodiment or an embodiment combining hardware and software aspects. Further, the embodiments, such as, the method associated with FIG. 7 may take the form of a computer program product stored on a computer-readable storage medium having computer-readable instructions embodied in the medium. For example, FIG. 9 depicts an electronic storage medium 900 on which computer program embodiments can be stored. Any suitable computer-readable medium may be utilized, including hard disks, CD-ROMs, digital versatile disc (DVD), optical storage devices, or magnetic storage devices such as floppy disk or magnetic tape. Other non-limiting examples of computer-readable media include flash-type memories or other known memories.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

1. A method for processing a call data record (CDR) in a communication network, the method comprising:
receiving a rejected CDR;
determining if a characteristic feature of the rejected CDR exceeds a first threshold;
performing a validation on the determination of the rejected CDR when the characteristic feature exceeds the first threshold;
removing access of a subscriber associated with the CDR from the communication network when the validation of the rejected CDR is negative; and
continuing to allow access of the subscriber associated with the CDR to the communication network when the validation of the rejected CDR is positive.

2. The method of claim 1, wherein the step of performing a validation on the determination when the rejected CDR exceeds the first threshold further comprises:
determining whether a subscriber or a service described in the rejected CDR is authorized by a customer care and billing platform (CC & B).

3. The method of claim 1, wherein the step of removing access of the subscriber associated with the CDR from the communication network when the validation of the rejected CDR is negative further comprises:
transmitting an provisioning message to a node in the communication network including instructions to deactivate the subscriber.

4. The method of claim 1, wherein the step of removing access of the subscriber associated with the CDR from the communication network when the validation of the rejected CDR is negative further comprises:
resetting the first threshold.

5. The method of claim 1, wherein the step of continuing to allow access of the subscriber associated with the CDR to the communication network when the validation of the rejected CDR is positive further comprises:
storing the positive validation result and performing a validation on the determination of a subsequent rejected CDR provided a second threshold is exceeded.

6. The method of claim 1, wherein the characteristic feature is a period of time elapsed since the threshold was last reset.

7. The method of claim 1, wherein the characteristic feature is an amount of data used by the subscriber since the threshold was last reset.

8. The method of claim 1, wherein the first and/or second threshold can vary between subscribers.

9. The method of claim 1, wherein when the first threshold is not exceeded, the subscriber maintains access to the communication network.

10. The method of claim 1, wherein the CDR is associated with a postpaid activity.

11. A system for processing a call data record (CDR) in a communication network, the system comprising:
a communication interface configured to receive a rejected CDR; and
a processor configured to;
determine if a characteristic feature of the rejected CDR exceeds a first threshold;
perform a validation on the determination of the rejected CDR when the characteristic feature exceeds the first threshold;
remove access of a subscriber associated with the CDR from the communication network when the validation of the rejected CDR is negative; and
continue to allow access of the subscriber associated with the CDR to the communication network when the validation of the rejected CDR is positive.

12. The system of claim 11, wherein to perform a validation on the determination when the rejected CDR exceeds a threshold further comprises:
to determine if a subscriber or a service described in the rejected CDR is authorized by a customer care and billing platform.

13. The system of claim 11, wherein to remove access of the subscriber associated with the CDR from the communication network when the validation of the rejected CDR is negative further comprises:
to transmit an automatic provisioning message to a predetermined node in the communication network including instructions to deactivate the subscriber.

14. The system of claim 11, wherein to remove access of the subscriber associated with the CDR from the communication network when the validation of the rejected CDR is negative further comprises:
to reset the threshold.

15. The system of claim 11, wherein to continue to allow access of the subscriber associated with the CDR to the communication network when the validation of the rejected CDR is positive further comprises:
to store the positive validation result and perform a validation on the determination of a subsequent rejected CDR provided a second threshold is exceeded.

16. The system of claim 11, wherein the characteristic feature is a period of time elapsed since the threshold was last reset.

17. The system of claim 11, wherein the characteristic feature is an amount of data used by the subscriber since the threshold was last reset.

18. The system of claim 11, wherein the first and/or second threshold can vary between subscribers.

19. The system of claim 11, wherein when the first threshold is not exceeded, the subscriber maintains access to the communication network.

20. The system of claim 11, wherein the CDR is associated with a postpaid activity.

21. A non-transitory computer-readable storage medium storing a computer-readable code for configuring a system for processing call data records (CDRs) to perform a method comprising:
receiving a rejected CDR;
determining if a characteristic of the rejected CDR exceeds a first threshold;
performing a validation on the determination of the rejected CDR when the characteristic feature exceeds the first threshold;
removing access of a subscriber associated with the CDR from the communication network when the validation of the rejected CDR is negative; and
continuing to allow access of the subscriber associated with the CDR to the communication network when the validation of the rejected CDR is positive.

22-25. (canceled)
